(19) United States
(12) Patent Application Publication
(10) Pub. No.: US 2021/0347235 A1
(43) Pub. Date: Nov. 11, 2021

(54) A THERMOPLASTIC LIFTGATE ARRANGEMENT HAVING BLOW MOLDED REINFORCEMENTS

(71) Applicants: Goodrich John KUNTZE, Goodrich, MI (US); Magna Exteriors Inc., Concord (CA)

(72) Inventors: Christopher John Kuntze, Goodrich, MI (US); Mark P. Birka, Northville, MI (US); Scott Varisto, St. Clair, MI (US); Stanislav Tichy, Troy, MI (US); Heiner Salzmann, Metamora, MI (US); Sinisa Andrasic, Kitchner (CA)

(73) Assignee: Magna Exteriors Inc., Concord, ON (CA)

(21) Appl. No.: 17/282,015

(22) PCT Filed: Nov. 6, 2019
(86) PCT No.: PCT/US19/60021

§ 371 Date: Apr. 1, 2021

Related U.S. Application Data
(60) Provisional application No. 62/758,059, filed on Nov. 9, 2018.

(51) Int. Cl. B60J 5/10; B29C 49/20

(52) U.S. Cl. CPC B60J 5/107; B29L 2031/3014; B29C 49/20

(57) ABSTRACT

A liftgate arrangement (10) including a thermoplastic inner panel (12) with an outer surface and an inner surface. The liftgate arrangement further includes one or more blow molded reinforcements (18, 20) connected to and extending across a portion of the outer surface of the inner panel (12). The one or more blow molded reinforcements (18, 20) also includes a hollow channel (22, 22′) extending between two openings on the one or more blow molded reinforcements. The one or more blow molded reinforcements (18, 20) are used to strengthen the inner panel at desired locations.

### FIELD OF THE INVENTION

The present invention relates to a liftgate arrangement implementing a blow molded reinforcement.

### BACKGROUND OF THE INVENTION

One of the current trends in the automobile industry is to lower vehicle weight to help achieve better fuel economy, thus helping to meet fuel economy standards and to offset the higher fuel prices. Another trend is that there is a broader range of vehicle models, which in turn reduces the volume of vehicles produced on a per model basis. Liftgates are traditionally made from stamped steel panels that are heavy and have a high tooling cost and are susceptible to corrosion. Sheet Molding Compound (SMC) is an alternative to steel for the inner and outer panels of the liftgate. Using SMC has several manufacturing concerns related to the material and process. Steel and SMC liftgates have a mass penalty over thermoplastics. There are also styling restrictions with traditional sheet metal and SMC components.

In certain applications where liftgates are made from composite materials, metal plates are used to strengthen the liftgate. The use of steel plates adds weight, can be difficult to attach and increases the assembly complicity. It is therefore desirable to design liftgates that have reinforcements that are easier to assemble, require less specific attachment points and provide an equivalent or greater level of strength than using metal inserts. It is further desirable to develop reinforcement structures that provide hollow channels that can be used for the attachment of other structures to the liftgate.

### SUMMARY OF THE INVENTION

The present invention is directed to a liftgate arrangement including a thermoplastic inner panel with an outer surface and an inner surface. The thermoplastic inner panel further includes a lower perimeter surface area, that includes the beltline, extending across substantially the entire width of the inner panel. The liftgate arrangement further includes one or more blow molded reinforcements connected to and extending across a portion of the outer surface of the inner panel.

The one or more blow molded reinforcements are used to strengthen the inner panel at desired locations. For example in one embodiment, the one or more blow molded reinforcements are used to strengthen the inner panel at a location often referred to as the D pillar. The one or more blow molded reinforcements also include a hollow channel extending between two openings on the one or more blow molded reinforcements. The hollow channel can serve many purposes, such as, providing strength to the blow molded reinforcement by providing a closed cell structure, providing a plenum or ductwork for heating and cooling passages, electrical wiring harness passages or hoses for fluids such as washer fluid or even a recess for receiving other accessories such as taillights, wipers, speakers, locks or latches, actuators or other objects. The hollow channel can also be filled with structural foam to add further strength.

The one or more reinforcements also include one or more mount surface areas formed on an exterior surface of the one or more blow molded reinforcements. The mount surface areas can be used for the attachment of tappet plates, hinges or other structures which would allow for the connection of other components such as hinges, pneumatic actuators, latch plates or other structures.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an angled perspective view of the liftgate inner panel with one blow molded reinforcement connected and a second blow molded reinforcement exploded away from the inner panel.

FIG. 1A is an enlarged view of the polymeric material of the body with reinforcing fibers.

FIG. 2 is an enlarged perspective view of an alternate embodiment of the invention showing a blow molded reinforcement connected to the liftgate inner panel using resistive implant welding with a wire mesh.

FIG. 3 is an enlarged rear view of a single blow molded reinforcement connected to the liftgate inner panel.

FIG. 4A is rear perspective view of the left side blow molded reinforcement with brackets attached and foam filler in the blow molded bracket according to an alternate aspect of the invention.

FIG. 4B is rear perspective view of the right side blow molded reinforcement with brackets attached and foam filler in the blow molded bracket according to an alternate aspect of the invention.

FIG. 5 are front side perspective views of the blow molded reinforcements.

FIG. 6 are rear side perspective views of the blow molded reinforcements.

FIG. 7 is a side perspective view of a blow molded reinforcement embodiment formed with a header reinforcement, a bottom reinforcement and two side reinforcements.

FIG. 8 is side perspective view of a blow molded reinforcement embodiment formed with a header and two sides formed as a single reinforcement piece.

FIG. 9 is a front side view of an inner panel with the blow molded reinforcements overmolded to the inner panel.

### DETAILED DESCRIPTION OF THE PREFERRED EMBODIMENTS

The following description of the preferred embodiment(s) is merely exemplary in nature and is in no way intended to limit the invention, its application, or uses.

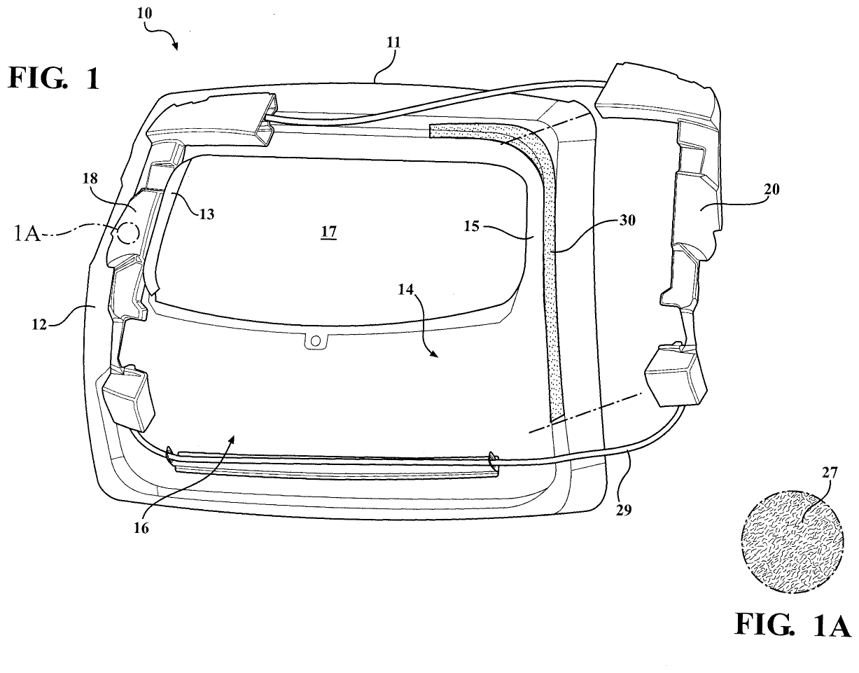

Referring now to the figures, with particular reference to FIG. 1, there is a liftgate structure arrangement 10 having an inner panel 12 formed of polymeric material. The inner panel 12 includes an outer surface 14 to which other structures are attached. The inner panel 12 forms the inner panel of the liftgate and other structures include support members, which will be discussed later as well as outer exterior show surface panels, tail lights, door latches etc. The inner panel 12 also includes a lower perimeter surface area 16 that includes the belt line, located below an aperture 17 that can be used to form a rear window of the liftgate arrangement 10. Extending upward from the lower perimeter surface area 16 are pillars 13, 15 that are referred to sometimes as D pillars when the liftgate arrangement 10 is connected to a vehicle. The pillars 13, 15 extend between the lower perimeter surface area 16 and a header 11. The header 11, pillars 13, 15 and lower perimeter surface area 16 define the boundary of the aperture 17.

In certain applications the inner panel 16 needs additional structural support. Depending on the application the support can be needed at any location on the inner panel 16, including but not limited to the area of the pillars 13, 15, header 11, beltline or lower surface area 16.

In order to provide the additional support to the inner panel, prior art applications have used metal plates connected to the inner panel. The present application provides blow molded reinforcements 18, 20 that are formed of a reinforced composite material. As shown accompanying figures, the blow molded reinforcements 18, 20 each have a hollow channel 22, 22′ extending between two openings 24, 24′, 26, 26′ on each of the blow molded reinforcements 18, 20. The hollow channel 22, 22′ is used to create a closed cell structure which adds strength to the blow molded reinforcements 18, 20. The hollow channel 22, 22′ is formed by blow molding so that a body 19, 19′ of each blow molded reinforcement 18, 20 has polymeric material. The body 19, 19′ can be formed of different types of material but generally including polymeric resin will such as polypropylene resin along with reinforcement fibers 27 Showing on FIG. 1A such as a glass fibers or carbon fibers. The methods of blow molding the blow molded reinforcements 18, 20 can include processes where the blow molded reinforcements 18, 20 are formed as one piece, two piece, multiple pieces, and subassembled, or installed as loose pieces.

The hollow channel 22, 22′ can serve several purposes and can be further reinforced with filler 31, 31′, such as, structural adhesives or foam materials, but could also be used for the routing of a tether 29 through different locations on the inner panel 12. The tether 29 serves as a retension mechanism that is routed through various points on the liftgate structure arrangement 10 to retain fragments of the liftgate arrangement in the event of an accident. It is also within the scope of the invention to use the hollow channel 22, 22′ for the routing of wire harnesses or water lines, channels for connecting lights, wiper motors, window actuators, door actuators or use for as HVAC ductwork.

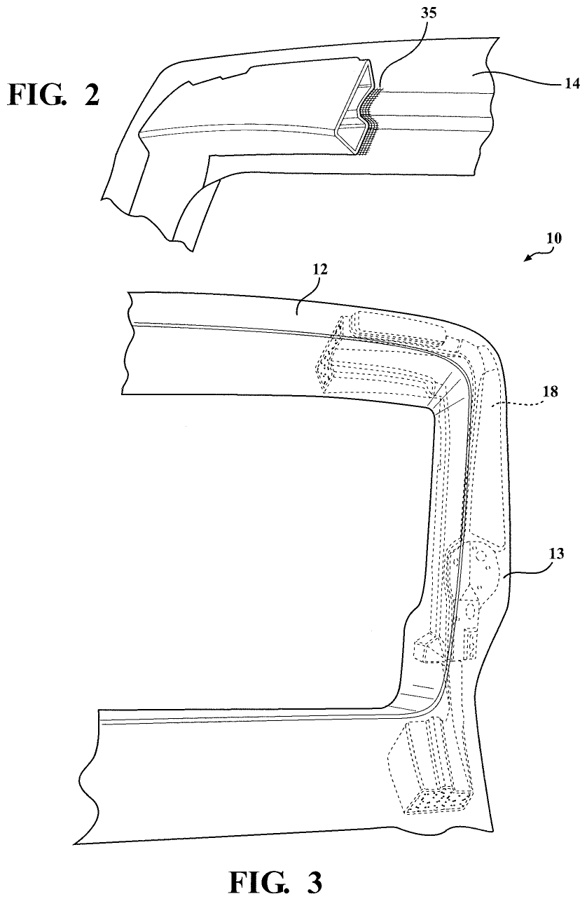

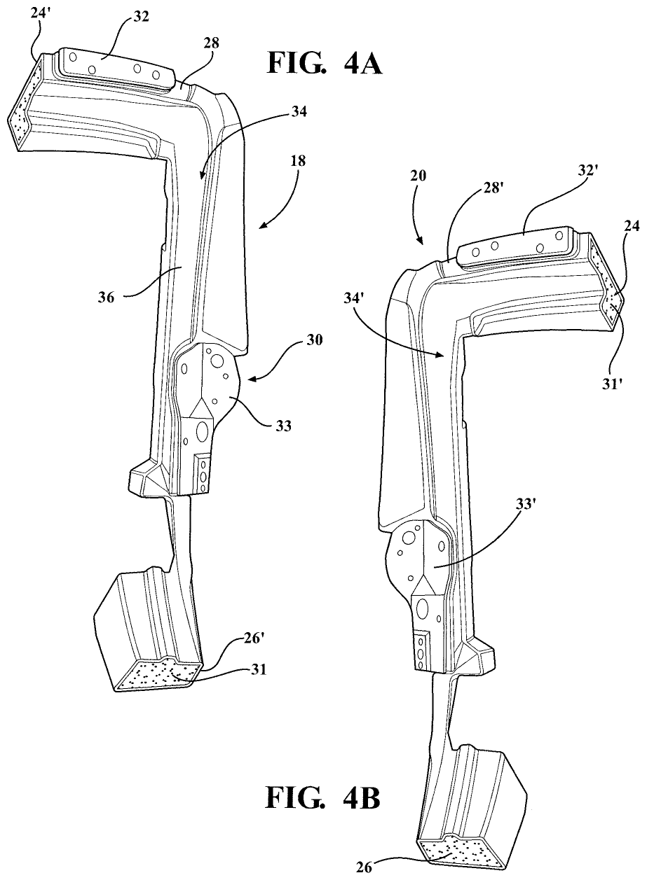

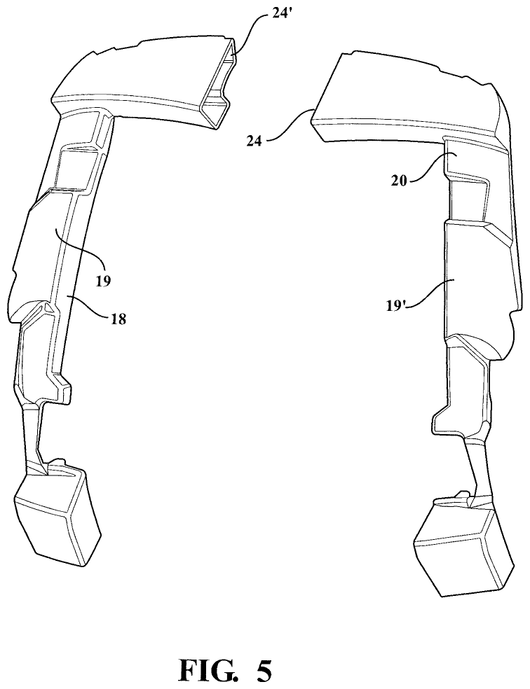

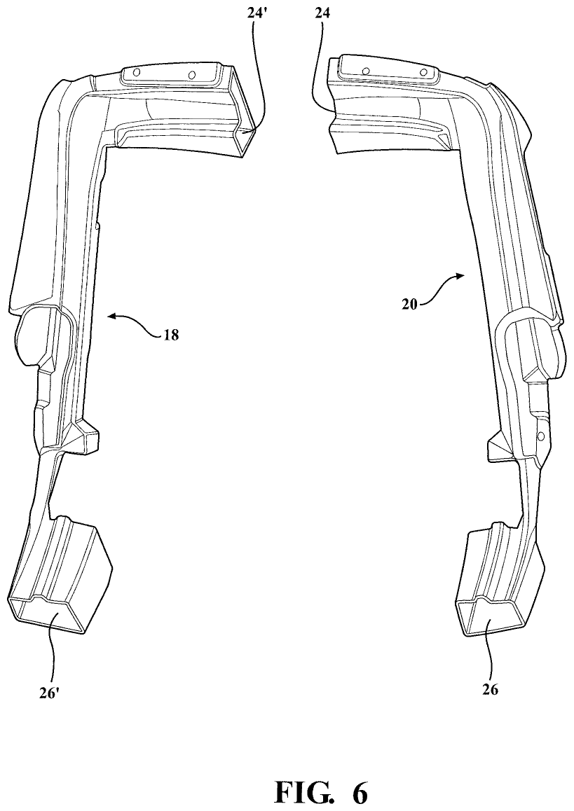

Referring now to FIGS. 1-3, 4A, 4B and 5 the details of the blow molded reinforcements 18, 20 are shown. FIG. 5 shows an outside surface 36, 36′ of the blow molded reinforcement 18, 20, while FIGS. 4A, 4B show the inside surface 34, 34′ of the blow molded reinforcement 18, 20. Shown in FIGS. 1 and 3 the inside surface 34, 34′ of blow molded reinforcements 18, 20 rest against an attachment surface 38, 38′ on the inner panel 12. The inside surface 34, 34′ of each blow molded reinforcement 18, 20 has mount areas 28, 28′, 30, 30′ which are surfaces where a bracket 32, 32′, 33, 33′ can be connected to the blow molded reinforcement 18, 20. The bracket 32, 32′, 33. 33′ can be a support plate for connection of a hinge or strut to the blow molded reinforcement 18, 20. While the bracket 32, 32′, 33, 33′ are shown being connected to the inside surface 34, 34′ of the blow molded reinforcement 18, 20 it is within the scope of the invention for the bracket 32, 32′, 33, 33′ to be connected to the outside surface of the blow molded reinforcement 18, 20.

The connection between the blow molded reinforcement 18, 20 and the attachment surface 38, 38′ of the inner panel 12 is accomplished using many different techniques. It is within the scope of this invention for the blow molded reinforcements 18, 20 to be mechanically attached, bonded, flanged or pinched in place. For example FIG. 1 shows adhesives 30 being used to bond the blow molded reinforcement 20 in place on the inner panel 12. It is further with scope of this invention for the connection or attachment of the blow molded reinforcements 18, 20 and the inner panel 12 to be accomplished using resistive implant welding, heat staking or in certain molding of the reinforcement such that the blow molded reinforcement is placed into the mold prior to formation of the inner panel 12. FIG. 2 shows a wire mesh 35 that is placed between the blow molded reinforcement 18 and outer surface 14 of inner panel 12. The wire mesh 35 is heated to resistive implant weld the blow molded reinforcement 18 to the inner panel 12.

Regarding the connection of the bracket 32, 32′, 33, 33′ to the respective mount areas 28, 28′, 30, 30′ it is within the scope of this invention for the bracket 32, 32′, 33, 33′ to be mechanically attached, insert/over molded connected with resistive implant wilding, heat staking or adhesives. The liftgate structure arrangement is only a portion of a completed liftgate. Once the liftgate structure arraignment 10 is formed other pieces such as glass, latches, locks, struts, exterior panels, etc. are added to create the completed liftgate.

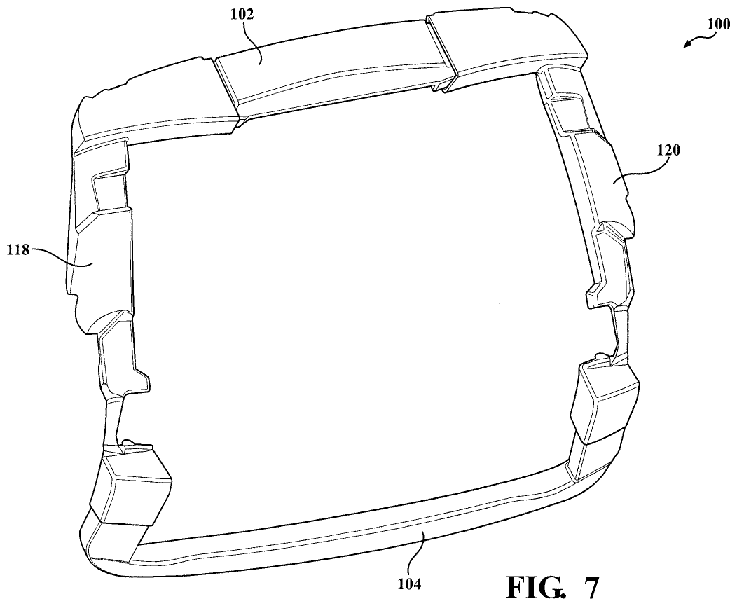

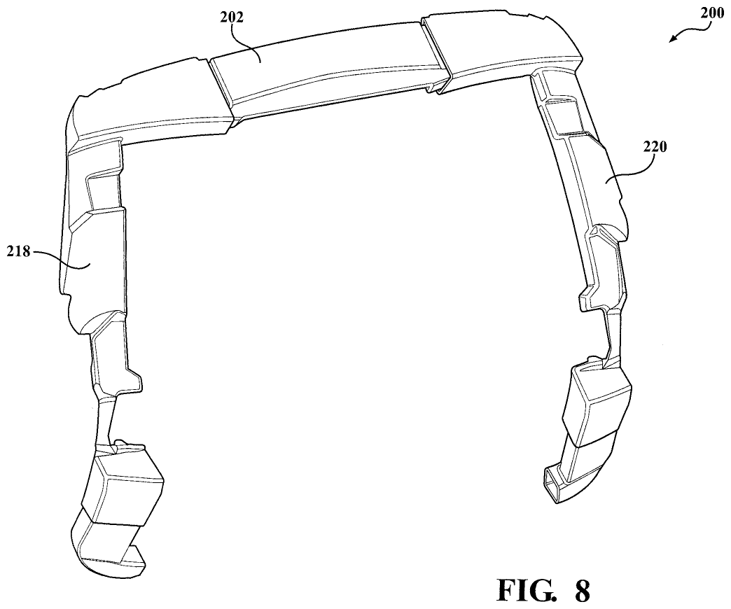

Referring now to FIG. 7 an alternate embodiment of the invention is shown. In this embodiment there is shown a one piece blow molded reinforcement 100 having a header 102 connected to a left side 118 and right side 120 along with a lower support 104. The one piece blow molded reinforcement 100 is formed using a blow molding process and is a single unitary piece that is then connected to an inner panel 12, as shown in the other figures. FIG. 8 depicts a second alternate construction showing a one piece blow molded reinforcement 200 having a header 202 connected as one piece with a left side 218 and right side 220 forming a generally upside down U shape. The one piece blow molded reinforcement 200 forms a single unitary piece that is connected to an inner panel 12, as shown in the other figures. The one piece blow molded reinforcements 100, 200 shown in FIGS. 7 and 8 provide additional support in the areas of the header and lower portion of the inner panel, while also providing a central hollow channel that can be used for additional structures such as tethers or can serve as a conduit for hoses or electrical harnesses.

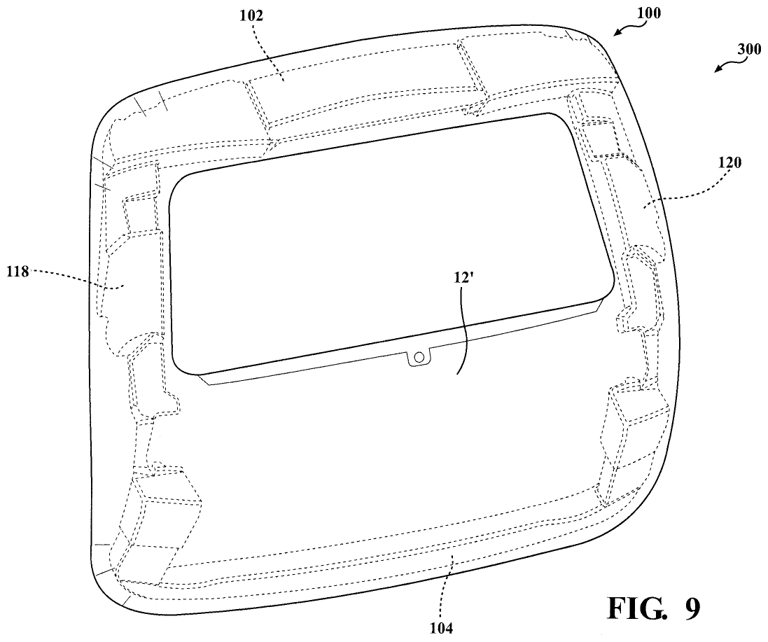

Referring now to FIG. 9 an alternate liftgate structure arrangement 300 is shown wherein the one piece blow molded reinforcement 100 has been connected to a liftgate inner panel 12′ using an overmolding or insert molding technique. The one piece blow molded reinforcement 100 is placed within the mold prior to formation of the inner panel 12′ and the header 102, left side 118, right side 120 and lower support 104 are encapsulated within the polymer material that forms the inner panel 12′. The use of the insert molding technique eliminates additional connection steps that can require adhesives, fasteners or resistive implant welding techniques as shown in the other embodiments.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A lift gate structure comprising:
an inner panel with an outer surface and an inner surface; and
at least one blow molded reinforcement connected to and extending across a portion of the outer surface of the inner panel, wherein said the at least one blow molded reinforcement has a hollow channel extending through the body of the at least one blow molded reinforcement, wherein the at least one blow molded reinforcement strengthens the lift gate structure.

2. The liftgate arrangement of claim 1 further comprising:
one or more mounting surfaces formed on an exterior surface of the at least one blow molded reinforcement; and
a bracket connected to each of the one or more mount surface areas.

3. The liftgate arrangement of claim 1 wherein the at least one blow molded reinforcement is formed of a material containing polymer and carbon fibers or glass fibers.

4. The liftgate arrangement of claim 1 wherein the at least one blow molded reinforcement is connected to the inner panel by one selected from the group including adhesives, resistive implant welding, heat staking, fasteners and combinations thereof.

5. The liftgate arrangement of claim 1, wherein the inner panel is made of polymer material and the at least one blow molded reinforcement is encapsulated in the polymer material of the inner panel.

6. The liftgate arrangement of claim 1, wherein the hollow channel is filled with structural foam, thereby increasing the strength of the at least one blow molded reinforcement.

7. The liftgate arrangement of claim 1, wherein the hollow channel contains a tether that extends through the hollow channel and connects two different points on the inner panel.

8. The liftgate arrangement of claim 1, wherein the inner panel includes one or more D pillars and the at least one blow molded reinforcement is connected to and extends across a portion of the one or more D pillars.

9. A lift gate structure comprising:
an inner panel with an outer surface and an inner surface having a lower perimeter surface area extending across substantially the entire width of the inner panel;
one or more blow molded reinforcements connected to and extending across a portion of the outer surface of the inner panel, wherein said one or more blow molded reinforcements has a hollow channel extending between two openings on the one or more blow molded reinforcements; and
one or more mount surface areas formed on an exterior surface of the one or more blow molded reinforcements.

10. The liftgate arrangement of claim 9 further comprising a bracket connected to each of the one or more mount surface areas.

11. The liftgate arrangement of claim 9, wherein the one or more blow molded reinforcements are formed of a material containing polymer and carbon fibers or glass fibers.

12. The liftgate arrangement of claim 9, wherein the one or more blow molded reinforcements are connected to the inner panel by one selected from the group including adhesives, resistive implant welding, heat staking, fasteners and combinations thereof.

13. The liftgate arrangement of claim 9, wherein the inner panel is made of polymer material and the one or more blow molded reinforcements are encapsulated in the polymer material of the inner panel.

14. The liftgate arrangement of claim 9, wherein the hollow channel is filled with structural foam, thereby increasing the strength of the one or more blow molded reinforcements.

15. The liftgate arrangement of claim 9, wherein the hollow channel contains a tether that extends through the hollow channel and connects two different points on the inner panel.

16. The liftgate arrangement of claim 9, wherein the inner panel includes one or more D pillars and the one or more blow molded reinforcements are connected and extend across a portion of the one or more D pillars.

17. A lift gate structure comprising:
an inner panel with an outer surface and an inner surface having a lower perimeter surface area extending across substantially the entire width of the inner panel, two D pillars extending upward from the lower perimeter surface and a header extending between the two D pillars;
a plurality blow molded reinforcements each one of the plurality of blow molded reinforcements is connected to a respective one of the two D pillars so that each one of the plurality of blow molded reinforcements extend across a portion of the respective one of the two D pillars, wherein said one or more blow molded reinforcements has a hollow channel extending between two openings on the one or more blow molded reinforcements; and
one or more mount surface areas formed on an exterior surface of each of the plurality of blow molded reinforcements.

18. The liftgate arrangement of claim 17 further comprising a bracket connected to each of the one or more mount surface areas.

19. The liftgate arrangement of claim 17, wherein the plurality of blow molded reinforcements are formed of a material containing polymer and carbon fibers or glass fibers.

20. The liftgate arrangement of claim 17, wherein the plurality of blow molded reinforcements are connected to the inner panel by one selected from the group including adhesives, resistive implant welding, heat staking, fasteners and combinations thereof.

21. The liftgate arrangement of claim 17, wherein the inner panel is made of polymer material and the plurality of blow molded reinforcements are encapsulated in the polymer material of the inner panel.

22. The liftgate arrangement of claim 17, wherein the hollow channel of each of the plurality of blow molded reinforcements is filled with structural foam, thereby increasing the strength of the plurality of blow molded reinforcements.

23. The liftgate arrangement of claim 17, wherein the hollow channel of each of the plurality of blow molded reinforcements contains a tether that extends through the hollow channel and connects two different points on the inner panel.
